(19) United States
(12) Patent Application Publication
(10) Pub. No.: US 2014/0279524 A1
(43) Pub. Date: Sep. 18, 2014

(54) Interchange Rate Based Convenience Fee, Service Fee, and Surcharge System Patent

(71) Applicants: Jeffrey Scott Slusser, Columbia, TN (US); Jeffrey Gardner, Nashville, TN (US)

(72) Inventors: Jeffrey Scott Slusser, Columbia, TN (US); Jeffrey Gardner, Nashville, TN (US)

(21) Appl. No.: 13/842,802

(22) Filed: Mar. 15, 2013

(51) Int. Cl. G06Q 20/42

(52) U.S. Cl. CPC G06Q 20/42
USPC 705/44

(57) ABSTRACT

Methods for processing payments electronically over a network-based system, such as Internet, phone, wireless communications, and other channels, wherein a third party or intermediary facilitates payment transactions to enable the processing of payments on behalf of individuals or businesses through credit card and debit card electronic transactions while providing a real-time, automated determination of a convenience fee associated with the transaction, the convenience fee being based upon the interchange rate for the specific card being used for the payment.

### BACKGROUND OF THE INVENTION

1. Field of the Invention

The present invention relates generally to electronic financial transactions, and more particularly to systems and methods for electronic payment transactions for automated real-time determination of fees based upon interchange rate.

2. Description of the Prior Art

Generally, it is known in the art to conduct financial transactions using a network-based system for transmitting and receiving electronic payments. By way of example, it is known to make electronic payments over a network-based system by transactions involving payments from individuals' and business' credit, debit, prepaid, ATM card, PayPal account, Bill Me Later account, or other electronic payment methods (“Electronic Payment”) for various types of payment transactions.

While it is known in the art for a third party to charge additional fees to a credit or debit card user making an electronic payment over a network-based system, generally these fees are determined as either a flat rate fee, a percentage of the transaction or minimum charge. In any case, the prior art fee charged applies equally to any and all credit and/or debit cards. Furthermore, in the Prior Art it is often the case that the fee is provided in advance of input and/or consideration of the credit or debit card number, which confirms that the fee is applied universally to any credit and/or debit card, without regard to possible differences in interchange rates associated with specific cards.

Examples of some relevant art documents that describe credit card payment convenience fee, service fee, and the like, include the following:

U.S. Patent Application Publication Nos. 20130013441 and 20120130842 for “Transaction Services Reverse Auction” by Giordano et al., assigned to Bank of America, filed Jun. 25, 2009 and Mar. 23, 2010 respectively, published Sep. 30, 2010 and May 24, 2012 respectively, describe a transaction service provided by one of arrangement participants to another of the participants, wherein a participant may select a supplier of the service based on a value associated with the service, wherein the value may be a fee, a rate, a reward, an incentive, an opportunity, and combinations thereof. A lower fee may correspond to a higher value. The transaction fee may depend upon one or more transaction fee factors, such as interchange rate, transaction processing network rates, merchant type, merchant size, transaction processing method, and other suitable factors. After the transaction fee is identified, processor may submit the transaction fee, via merchant components, to point of sale (POS) terminal, which may display the transaction fee for viewing by the customer. The POS terminal may have one or more interactive features that the customer may use, such as information to help the consumer decide whether to execute the transaction. The customer may use the features to obtain more information about the merchant, the transaction, the transaction fee, transaction fees associated with different purchasing instruments (e.g., credit cards, debit cards, instruments or devices that include a contact chip), or combinations thereof. In some embodiments, the system may provide automatic bidding, including a bid-offer engine (software or hardware), with rules applied to apply bids to the offer, and the highest value supplier bid may be identified.

U.S. Patent Application Publication Nos. 20130013495 and 20110238596 for “Transaction Information Routing” by Giordano et al., assigned to Bank of America, filed Sep. 14, 2012 and Mar. 26, 2010 respectively, published Jan. 10, 2013 and Sep. 29, 2011 respectively, describe more than one participant of a given type may be able to participate in a transaction, wherein different participants of the same type have advantages and/or disadvantages relative to other participants of the same type. For example one issuer may be a member of a leading consortium while another is not a member, one network may require payment of a small interchange fee while another network requires payment of a large interchange fee. The customer may select a card that is associated with an issuer, and may select a signature-based transaction or a PIN-based transaction, wherein the selections may fulfill conditions necessary for application of the rule, or not.

U.S. Patent Application Publication No. 20100250379 for “Interactive Interchange Rate Decisioning” by Giordano et al., assigned to Bank of America, filed Jun. 25, 2009, published Sep. 30, 2010, describes an apparatus and methods that may enable merchants to pass along interchange costs or to provide incentives to the customer at a point of sale (POS) at which time at the POS the customer may then decide which card or payment mechanism to use, e.g., the customer may choose to use a credit card that results in the lowest transaction cost or a credit card that provides incentives, e.g., cash back, cash rewards, non-cash rewards, benefits, etc., which may be accruable. The transaction fee may be based on one or more transaction factors, such as interchange rate, network rates, merchant type, merchant size, transaction processing method.

U.S. Patent Application Publication No. 20110101091 for “Interchange Optimization for Payment Processing” by Jorge Fernandez, filed Dec. 9, 2009, published May 5, 2011, describes a method that can include determining card association for the card number and retrieving criteria for the lowest interchange rate for the card association, and prompting the merchant to provide data required by the retrieved criteria and assembling a transaction for the proposed transaction with the required data, and routing the assembled transaction to a selected payment processor. A card association for a swiped card in the card processing POS terminal can be determined and criteria requisite to a lowest exchange rate charged by the card association can be loaded, and optimization criteria pre-specified preferentially by the merchant can be loaded. The card association criteria and the optimization criteria can be mapped to the required data for a transaction and the merchant can be prompted to provide the required data through the card processing POS terminal or a computer display coupled to the card processing POS terminal Only once the required data is provide, the processing of a transaction on the swiped card can proceed.

U.S. Pat. Nos. 8,095,438 and 8,266,057 for “Methods and systems for assigning interchange rates to financial transactions using an interchange network” by Carroll et al., assigned to MasterCard International Incorporated, filed Dec. 28, 2007 and Dec. 12, 2011 respectively, and issued Jan. 10, 2012 and Sep. 11, 2012 respectively, describe a method that includes accessing the interchange database, matching the transaction data including the identity of the issuer bank with the issuer data stored within the interchange database, and automatically assigning an interchange rate to the transaction based on the received transaction data and the issuer data stored within the interchange database. The systems and processes facilitate rewarding the card issuer for being an exclusive or priority client of the transaction card association or network. The data may also include whether particular bank identification numbers (BINs) of cards, or subsets of the cards issued by the issuer bank, have a special relationship with the bank.

U.S. Patent Application Publication No. 20120078790 for “Real-Time Interchange Fee Estimation” by Ornce et al., filed Jun. 10, 2011 and published Mar. 29, 2012, describes providing a merchant with an estimated interchange fee in real-time, which may be provided as part of an authorization or settlement processing method.

U.S. Patent Application Publication No. 20110106638 for “Cash Management Optimization for Payment Processing” by Jorge Fernandez, filed Dec. 9, 2009 and published May 5, 2011, describes a method, system and computer program product for cash management optimization method for payment processing. In an embodiment of the invention, a cash management optimization method for payment processing can include receiving a transaction profile for a proposed transaction as payment for a purchase by a purchaser from a merchant at a card processing terminal configured to identify a card number for a card. The method further can include comparing the transaction profile to merchant-specified preferences mapping different transaction profiles to different payment processors. A payment processor for the proposed transaction can be selected based upon the comparison of the transaction profile to the merchant-specified preferences.

U.S. Patent Application Publication No. 20110106695 for “Payment Processing System, Method And Computer Program Product” by Jorge Fernandez, filed Oct. 29, 2009 and published May 5, 2011, describes a method and computer program product for least cost routing in payment processing. In an embodiment of the invention, a payment processing method can include receiving a transaction profile for a proposed transaction as payment for a purchase by a purchaser from a merchant at a card processing terminal configured to identify a card number for a card. The method further can include computing a cost of processing the proposed transaction for each of multiple different payment processors based upon the received transaction profile. The method yet further can include selecting one of the different payment processors corresponding to a lowest cost of processing computed for the received transaction profile. Finally, the method can include routing the proposed transaction to the selected one of the different payment processors.

U.S. Patent Application Publication No. 20110106609 for “Electronic Couponing for Payment Processing” by Jorge Fernandez, filed Dec. 9, 2009 and published May 5, 2011, describes a method, system and computer program product for electronic couponing for payment processing. In an embodiment of the invention, an electronic couponing method for payment processing can include receiving a transaction profile for a proposed transaction as payment for a purchase by a purchaser from a merchant at a card processing terminal configured to identify a card number for a card. The method also can include presenting a coupon in the card processing terminal responsive to the transaction profile. Yet further, the method can include prompting the purchaser to redeem the coupon through the card processing terminal. Finally, the method can include reducing a payment amount for the proposed transaction if the purchaser redeems the coupon through the card processing terminal and routing the proposed transaction to a payment processor for payment processing.

U.S. Patent Application Publication No. 20120296726 for “System and Method for Managing Transactions with a Portable Computing Device” by Dessert et al., assigned to Firethorn Mobile, Inc., filed Nov. 11, 2011 and published Nov. 22, 2012, describes a method and system include verifying credentials for gaining access to a central mobile payment controller using the portable computing device (“PCD”). The central mobile payment controller may receive a merchant identifier corresponding to a merchant and then it may compare the merchant identifier against loyalty account data stored in a database. The central mobile payment controller through a tender steering module may determine if a profile of the portable computing device is associated with a merchant branded payment account and/or with a merchant branded stored value account. The central mobile payment controller may produce a message that lists one or more preferred payment options in a ranked fashion that may favor a merchant based on interchange rates.

U.S. Pat. No. 8,078,531 for “Bin Routing For Payment Processing” by Jorge Fernandez, filed Dec. 9, 2009 and issued Dec. 13, 2011, describes a method and computer program product for bank identification number (BIN) routing. In an embodiment of the invention, a BIN routing method can include receiving a transaction profile for a proposed transaction as payment for a purchase by a purchaser from a merchant at a card processing terminal configured to identify a card number for a card. A BIN can be extracted from the card number a financial institution can be determined from a list of financial institutions pre-specified to be related to the BIN. Thereafter, the proposed transaction can be routed to the determined financial institution related to the BIN.

U.S. Patent Application Publication No. 20080270275 for “Auditing or Determining Reductions to Card-Issuer Interchange Fees” by McElroy et al., assigned to PE Systems, filed Apr. 25, 2007 and published Oct. 30, 2008, describes tools capable of auditing and/or determining reductions to card-issuer interchange fees charged for credit-card transactions. The tools may do so automatically and with user interaction for thousands or even millions of transactions.

U.S. Patent Application Publication No. 20090234748 for “Interchange Fee Notification” by Skowronek et al., assigned to First Data Corp., filed Mar. 11, 2008 and published Sep. 17, 2009, describes systems and methods that alert a merchant of increased interchange fees. An increased interchange fee occurs when an electronic transaction, such as a credit card transaction, deviates from a standard set of criteria. For example, the sales person enters the credit card number rather than swipe the magnetic stripe of the credit card. In one embodiment, transaction information is provided to a merchant. The merchant sends the transaction information to an application. If the transaction is non-standard, the application can produce a notification that is sent to the merchant. The merchant may then address the causes of the increased interchange fee.

U.S. Patent Application Publication No. 20100088204 for “Method and Apparatus for Dynamic Interchange Pricing” by Nambiar et al., filed Oct. 7, 2007 and published Apr. 8, 2010, describes methods for determining and assessing dynamic interchange fees based on payment card account spending history using a spending history database.

U.S. Patent Application Publication No. 20110302080 for “Method and Apparatus for Value Interchange Pricing” by White et al., filed Jun. 3, 2011 and published Dec. 8, 2011, describes a method including the step of establishing dynamic interchange pricing based on a payment account's relative or actual value.

U.S. Pat. No. 8,019,680 for “Altering Card-Issuer Interchange Categories” by McElroy et al., assigned to PE Systems, LLC, filed Oct. 12, 2009 and issued Sep. 13, 2011, describes tools capable of determining ways in which to alter interchange categories assigned to credit-card transactions. In some embodiments, the tools receive parameters for interchange categories and transaction information for a client (e.g., one or more merchants) that has been charged interchange fees based on some of these categories. The tools may determine, based on these parameters and transaction information, how parameters may be changed to enable similar credit-card transactions to be assigned a lower-cost interchange category and the accompanying potential fee savings.

U.S. Pat. No. 8,019,681 for “Interchange Categories” by McElroy et al., assigned to PE Systems, LLC, filed Dec. 31, 2009 and issued Sep. 13, 2011, describes tools capable of altering to which interchange categories credit-card transactions are assigned. In some embodiments, the tools receive parameters for interchange categories and transaction information for a client (e.g., one or more merchants) that has been charged interchange fees based on some of these categories. The parameters are utilized (e.g., by a credit card issuer) to determine to which interchange category a particular transaction will be assigned. The tools may determine, based on these parameters and the transaction information, how transactions may be changed to enable similar credit-card transactions to be assigned to a lower-cost interchange category.

U.S. Pat. No. 8,024,268 for “Altering Card-Issuer Interchange Categories” by McElroy et al., assigned to PE Systems, LLC, filed Sep. 4, 2009 and issued Sep. 20, 2011, describes tools capable of determining ways in which to alter interchange categories assigned to credit-card transactions. In some embodiments, the tools receive parameters for interchange categories and transaction information for merchants that have been charged interchange fees based on some of these categories. The tools may determine, based on these parameters and transaction information, how parameters may be changed to enable similar credit-card transactions to be assigned a lower-cost interchange category and the accompanying potential fee savings.

U.S. Pat. No. 8,244,634 for “Interchange Categories” by McElroy et al., assigned to PE Systems, LLC, filed Sep. 19, 2011 and issued Aug. 14, 2012, describes tools capable of altering to which interchange categories credit-card transactions are assigned. In some embodiments, the tools receive parameters for interchange categories and transaction information for a client (e.g., one or more merchants) that has been charged interchange fees based on some of these categories. The parameters are utilized (e.g., by a credit card issuer) to determine to which interchange category a particular transaction will be assigned. The tools may determine, based on these parameters and the transaction information, how transactions may be changed to enable similar credit-card transactions to be assigned to a lower-cost interchange category.

U.S. Pat. No. 7,603,312 for “Altering Card-Issuer Interchange Categories” by McElroy et al., assigned to PE Systems, filed Apr. 25, 2007 and issued Oct. 13, 2009, describes tools capable of determining ways in which to alter interchange categories assigned to credit-card transactions and the accompanying potential fee savings. In some embodiments, the tools receive parameters for interchange categories and transaction information for merchants that have been charged interchange fees based on some of these categories. The tools may determine, based on these parameters and transaction information, parameter changes that enable similar credit-card transactions to be assigned a lower-cost interchange category and the accompanying potential fee savings.

U.S. Pat. No. 8,301,559 for “Determination of Interchange Categories” by McElroy et al., assigned to PE Systems, LLC, filed Nov. 30, 2011 and issued Oct. 30, 2012, describes tools capable of auditing and/or determining reductions to card-issuer interchange fees charged for credit-card transactions. The tools may do so automatically and with user interaction for large amounts of transactions.

U.S. Pat. No. 7,873,540 for “Virtual Terminal Payer Authorization Systems and Methods” by Avin Arumugam, assigned to First Data Corp., filed Sep. 20, 2006 and issued Jan. 18, 2011, describes a method of obtaining payer authorization for a purchase instrument transaction with a customer includes using a wireless device of a merchant to contact a virtual terminal service to process the transaction, entering transaction information into the wireless device, which transaction information includes an account identifier relating to the purchase instrument of the customer, forwarding the transaction information from the wireless device to the virtual terminal service, receiving at the wireless device a request from the virtual terminal service to receive payer authorization information from the customer, receiving the payer authorization directly from the customer into the wireless device of the merchant, forwarding the payer authorization from the wireless device to the virtual terminal service, and receiving an approval message from the virtual terminal service at the wireless device of the merchant.

None of the prior art references identified hereinabove teach or describe all of the elements of the present invention, and none address the longstanding unmet need in the art to provide more transparency and flexibility to the processes associated with additional transaction fees (“convenience fees”) associated with credit or debit cards for electronic network-based transactions. Thus there remains a need for the solutions provided by the present invention as described herein.

### SUMMARY OF THE INVENTION

The present invention is directed to methods for processing payments electronically over a transaction processing network (a “network-based system”), such as Internet, phone, wireless communications and other channels, wherein a third party or intermediary facilitates payment transactions to enable the processing of transactions on behalf of individuals through credit and debit card electronic transactions while providing a real-time, automated determination of the convenience fees associated with the transaction, the fee based, at least partly, upon interchange rate for the specific card being used for the payment.

One embodiment of the present invention provides a method for processing transactions electronically over a network-based system including the steps of: providing a system for conducting transactions directly to any entity for receiving and remitting payments from individuals or businesses; initiating a transaction for making a payment on behalf of an individual cardholder; receiving electronic payment information or data and corresponding to a cardholder account, specifically a unique number for a card; automatically making a real-time lookup for an interchange rate associated with the card; automatically transforming the interchange rate into a convenience fee by combining all factors associated with any fees for the specific transaction with the real-time lookup of the interchange rate; presenting the information of the convenience fee to the cardholder for approval.

Significantly, the convenience fee is generated, at least partly, from the individual real-time interchange rate for the specific card number provided by the cardholder, which number is often received by the system in advance of making the lookup for that interchange rate. Thus, the interchange rate included in the convenience fee is card-specific, and the convenience fee determined is also based upon the information associated with the card number provided.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a flow diagram illustrating one embodiment of steps involved in a card transaction over a network-based system.

FIG. 2 is a schematic diagram of a computer network and remote access occurring over a network-based system.

FIG. 3 is a flow diagram representing one embodiment of the entities exchanging information during a card transaction.

FIG. 4 is a schematic diagram of one embodiment of the information exchange occurring during a convenience fee calculation.

### DETAILED DESCRIPTION

The following definitions are provided to indicate usage of the terms in this document:

Acquirer means a financial institution that contracts with Merchants to enable card transactions or disburse currency to a Cardholder, and directly or indirectly enters the resulting Transaction receipt into the Interchange.

BIN means a number, usually 6 digits, assigned by a Card Association and used to identify a Card Association member or Processor for authorization, clearing, settlement processing, or similar processes or services.

Card means all credit, debit, ATM, and prepaid cards

Card Association means MasterCard International, Visa U.S.A. or Visa International, or any other entity that are licensing regulatory agencies for bankcard activities.

Cardholder means an individual who is issued and authorized to use a Card or has a virtual account that functions similar to a Card when making electronic payments.

Convenience Fee means a charge to the Cardholder in addition to the original transaction amount; calculations of such may be based on factors such as Dues and Assessments, Interchange Fees, Service Provider Fees, and/or any other fees additional to the original transaction amount; also referred to as a Service Fee or Surcharge.

Dues and Assessments means the processing fees paid to the Card Associations to finance their roles in operating the network, setting rules, setting pricing, research and development, and marketing and branding; calculated both as a set percentage of the sale and a fixed dollar amount and are generally collected on a daily and/or monthly basis.

Interchange means the standardized electronic exchange of financial and non-financial data associated with sale and credit data between Merchant, Acquirers, Card Associations, and other entities on various types of transactions.

Interchange Fee means a fixed amount per Transaction and/or percentage applied, according to Card Association regulations, to the dollar value of each Transaction.

Interchange Rate means a fee paid by an Acquirer to an issuing bank for transactions entered into the Interchange; Card Associations each have their own criteria for their own fee categories, each fee category having its own applicable Interchange Rate; specific criteria is evaluated for each Transaction to determine the applicable Interchange Fee; also called Interchange Reimbursement Fee (IRF); e.g., if the Interchange Rate is 1.43%+USD 0.05, and the Transaction amount is USD 100, then the calculated Interchange Fee=(USD 100×1.43%)+USD 0.05=USD 1.48.

Merchant means an entity that contracts with an Acquirer, Processor and/or a Service Provider to originate Transactions.

Network-based System means any transaction processing network, such as Internet, phone, wireless communications, and other channels.

Payment Channel means the delivery method by which Transactions are sent to a Processor; e.g., the Internet, Interactive Voice Response (IVR) phone service, Automated Clearing House (ACH), and lockbox.

Payment Gateway means a service or system for transmitting and receiving transaction information from a website, Interactive Voice Response system, point-of-sale device, or other network-based systems to a Processor or Acquirer.

Payment Method means the means of payment employed by a purchaser, such as cash, check, money order, or Card.

Processor means an entity that routes transaction information to a Card Association or Network-based System.

Service Provider means an entity that contracts with an Acquirer and/or Processor and/or Merchant to provide payment services to a Merchant.

Service Provider Fee means the fee(s) charged by a Service Provider, Acquirer, Processor, Merchant or other entity that is assessing the Convenience Fee(s).

Surcharge means a fee that a Merchant or Service Provider adds to the cost of a purchase when a customer uses a Card.

Transaction means any action between a Cardholder and a Merchant, Service Provider, Acquirer, Processor or other entity that results in activity on the Card account, such as a purchase, payment, cash advance or credit.

Referring now to the drawings in general, the illustrations are for the purpose of describing a preferred embodiment of the invention and are not intended to limit the invention thereto. The present invention provides methods of electronically processing transactions over a network-based system, preferably the Internet, phone, or any other communications network, including real-time lookup of an interchange rate associated with a specific card for conducting the transaction, and transforming the interchange rate into a convenience fee, including transparent indication of factors in generating the convenience fee, and providing selection options for the cardholder to approve or decline the total fee presented, either alone or in comparison to alternatives having a lower total fee, including lower interchange rate based on real-time lookup for cards associated with different issuing banks, networks, and combinations thereof.

Since the prior art set forth in the foregoing does not provide the solutions that continue to exist as a longstanding and unmet need, there remains a need for processing transactions electronically over a network-based system, with a real-time lookup of an interchange rate associated with the card or BIN number provided by the cardholder for making the electronic transaction, and for providing a transparent indication of itemized factors included in a convenience fee, which includes the real-time lookup of the interchange rate for that specific card and corresponding specific transaction.

Convenience fees are currently either charged to the cardholder as a separate transaction or combined with the original transaction amount that is settled to the merchant. The prior art for assessing convenience fees does not calculate the convenience fee on an individual transaction basis based on the actual fees and factors associated with the card, such as the individual cardholder's interchange rate. Therefore, since the convenience fees charged to the cardholder are not based on the actual card used on an individual transaction basis, cardholders paying a given merchant, are charged the same convenience fee based on the merchant, payment method, payment channel, the service provider, merchant or acquirer's underlying aggregate cost structure and/or if the cardholder is using a credit, debit, or prepaid card. This creates an issue where a cardholder paying a merchant may be using a card that has lower real-time convenience fee than another Cardholder's Card, however the convenience fee assessed to both cardholders is the same.

Prior Art Example 1 involves Cardholder 1 making a $500.00 citation payment with a merchant using a “Visa Signature Preferred CPS/Card Not Present” Interchange Reimbursement Fee Card and Cardholder 2 making a $500.00 citation payment to a merchant using a “Visa CPS/Retail 2” Interchange Reimbursement Fee Card. The underlying Interchange Rate cost of the Visa Signature Preferred CPS/Card Not Present Interchange Reimbursement Fee Card is $12.10 and the underlying interchange rate cost of the Visa CPS/Retail 2 Interchange Reimbursement Fee Card $7.20. In this example the convenience fee charged to both Cardholder 1 and Cardholder 2 is 2.50% based on the $500.00 citation transaction amount or $12.50. The convenience fee is the same for Cardholder 1 and Cardholder 2 even though the underlying interchange rate cost of Cardholder 1 transaction is $12.10 and the underlying interchange rate cost of Cardholder 2 transaction is $7.20. This problem leads to lower interchange rate cost card transactions subsidizing the cost of higher cost cards when the convenience fee is the same for both of the aforementioned cardholders.

Prior Art Example 2 involves Cardholder 1 making a $1000.00 tax transaction using a “MasterCard Consumer Debit Emerging Markets” Interchange Rate Card and Cardholder 2 making a $1000.00 tax transaction using a “MasterCard Regulated POS Debit” Interchange Rate Card. The underlying interchange rate cost of the MasterCard Consumer Debit Emerging Markets Interchange Rate Card is $8.53 and the underlying interchange rate cost of the MasterCard Regulated POS Debit Interchange Rate Card is $0.92. The convenience fee charged to both Cardholder 1 and Cardholder 2 is $3.95 regardless of the transaction amount. The convenience fee is the same for Cardholder 1 and Cardholder 2 even though the underlying interchange rate cost of Cardholder 1 transaction is $8.53 and the underlying interchange rate cost of Cardholder 2 transaction is $0.92. This problem leads to lower interchange rate cost cards to subsidize the cost of higher cost cards when the convenience fee is the same for both of the aforementioned cardholders.

By contrast to the prior art, the present invention provides real-time interchange rate lookup based upon the received card number information at the time it is received. The present invention calculates the convenience fee for each individual transaction based on the actual card interchange rate associated with card that is being used to pay the merchant.

Under the present invention the convenience fee is determined for each individual transaction that is made to a given merchant by preforming a BIN file lookup, or other real-time interchange rate lookup method, in real-time upon receipt of the card number information to determine the actual interchange rate associated with the card that is being used to pay the merchant. The interchange rate cost is then combined with dues and assessments, surcharges, service provider fee(s), and other fees and factors to determine the convenience fee that is charged to the cardholder.

Furthermore, the present invention provides the ability to charge the same consistent service provider fee(s) to all transactions for a given merchant regardless of the interchange rate. Therefore, the convenience fee charged to each cardholder may vary based on the card that is used to process a transaction.

In one embodiment of the present invention, the “mark-up” above the actual interchange rate or the additional fees included in the generation of the convenience fee is consistent for a given merchant. By way of example and not limitation, for the purpose of illustrating the present invention, in such a case the convenience fee may be equal to the mark-up of 0.20%+$0.20 above the actual interchange rate for a given transaction for a given merchant.

Present Invention Example 1 involves Cardholder 1 making a $500.00 citation payment using a “Visa Signature Preferred CPS/Card Not Present” Interchange

Reimbursement Fee Card with a 0.20% service provider fee(s) and Cardholder 2 making a $500.00 citation payment using a “Visa CPS/Retail 2” Interchange Reimbursement Fee Card with a 0.20% service provider fee(s). The underlying interchange rate cost of the Visa Signature Preferred CPS/Card Not Present Interchange Reimbursement Fee Card is $12.10 and the underlying interchange rate cost of the Visa CPS/Retail 2 Interchange Reimbursement Fee Card $7.20. According to the present invention, the convenience fee charged to Cardholder 1 is $13.10 and the convenience fee charged to Cardholder 2 is $8.20. Furthermore, the present invention eliminates the issue of having lower interchange rate cost card transactions subsidizing the cost of higher cost cards when the convenience fee is the same for both of the aforementioned cardholders.

Present Invention Example 2 involves Cardholder 1 making a $1000.00 tax transaction using a “MasterCard Consumer Debit Emerging Markets” Interchange Rate Card with a 0.20% service provider fee(s) and Cardholder 2 making a $1000.00 tax transaction using a “MasterCard Regulated POS Debit” Interchange Rate Card with a 0.20% service provider fee(s). The underlying interchange rate cost of the MasterCard Consumer Debit Emerging Markets Interchange Rate Card is $8.53 and the underlying interchange rate cost of the MasterCard Regulated POS Debit Interchange Rate Card $0.92. Under the present invention, the convenience fee charged to Cardholder 1 is $10.53 and the convenience fee charged to Cardholder 2 is $2.92. Furthermore the present invention eliminates the issue of having lower interchange rate cost card transactions subsidizing the cost of higher cost cards when the convenience fee is the same for both of the aforementioned cardholders.

In one embodiment, the present invention provides a method for processing transactions electronically over a network-based system including the steps of: providing a system or device for conducting transaction directly with any entity for receiving and remitting transaction amounts from individuals; initiating a transaction on behalf of an individual cardholder or a business cardholder; receiving transaction information or data and corresponding to a cardholder account, specifically a unique number for a credit card or a debit card; automatically making a real-time lookup for an interchange rate associated with the credit card or debit card; automatically transforming the interchange rate into a convenience fee by combining all factors associated with any fees for the specific transaction with the lookup of the interchange rate; and presenting the information of the convenience fee to the cardholder for approval.

In another embodiment of the present invention, the system or device is operable to transparently provide itemized information for each factor used to determine the convenience fee. Preferably, the itemized information includes at least one of the following fees: interchange fee, dues and assessments, service provider fee(s), and combinations thereof. Additional steps may include receiving approval of the cardholder for the convenience fee presented, or receiving decline of approval by the cardholder. If a decline of approval is received, then the cardholder may repeat the above steps for a second card, including the unique number associated with the second card. This may be repeated N times until the cardholder approves the convenience fee presented. Additionally, or alternatively, the method of the present invention may further include a step of presenting a multiplicity of card issuers and associated lower interchange rates and/or convenience fees compared with the interchange rate and/or convenience fee of the first card information provided by the cardholder. In this case, the cardholder has the option of providing an alternate card number, and the above steps are repeated N times until the cardholder approves the convenience fee presented. In one embodiment, multiple card numbers may be entered for transmitting and for receipt and lookup automatically by the system, wherein multiple convenience fees are generated and provided, which correspond to each of the multiple cards.

More specifically, as illustrated by the flow diagram of FIG. 1 the present invention additionally provides a method for making electronic financial transactions with merchants, service providers, creditors, or any transaction amount recipient including the steps of: providing a network for making electronic data communications, including secure transmission of transaction data for transmitting electronic transactions between a cardholder and a transaction amount recipient, over a network-based system; initiating a transaction over the network, optionally via a web-based interactive user interface, or making the electronic payment; receiving cardholder information, including card type (credit or debit), card number, expiration date, cardholder name, etc., with at least the card number data being provided; automatically making a real-time bank identification number (BIN) lookup, or other real-time interchange rate lookup method, to determine the actual real-time interchange rate for that specific card number provided; automatically transforming the interchange rate into a convenience fee rate for processing that specific card for the amount associated with the specific transaction entered; receiving authorization and data for use of the specific card with the specific convenience fee; receiving authorization and data approving the electronic transaction. Other method steps according to the present invention include automatically indicating alternative credit card issuing banks having lower interchange rates for the specific transaction; prompting the cardholder to confirm the transaction, or to enter another card number. Repeating these until receiving input that the cardholder approves the convenience fee.

In one embodiment of the present invention, the step of automatically indicating alternative credit card and/or debit card issuing banks having lower interchange rates for the specific transaction further includes presenting information via the web-based graphical user interface “GUI” (or other interface) showing a comparison of a multiplicity of alternative card types and/or issuing banks that provide lower interchange rates, and where applicable lower convenience fees, for the specific transaction. Also, the interchange rates associated with each of those cards is displayed. Other steps may be included for prompting the cardholder to input multiple card numbers from different cards into separate fields in a web-based GUI (or other interface); with a subsequent step of the system automatically generating a new convenience fee for each card number inputted by the cardholder and received by the server associated with the system. Preferably, for multiple card number entries, the cardholder is presented and provides an input to select the desired card number and associated convenience fee, approve the transaction, submit electronically and complete the transaction.

Another step may optionally include ranking the presented information in order of lowest total fees to highest total fees. Additionally, a step of prompting the cardholder to select one of the presented options is provided. Where the cardholder provides inputs that are received, then a subsequent step of automatically generating a new total fee is provided, wherein the new total fee is determined based upon the credit card information provided and received as inputs from the cardholder. Preferably, these steps are repeated until the transaction is approved by the cardholder, submitted electronically, and completed.

Another embodiment or method step of the present invention provides the cardholder with at least one of the factors or fees used in the calculation of the convenience fee. Providing this information to the cardholder educates the cardholder as to the options available and to the underlying factors and fees that determine the convenience fee. Other optional method steps and embodiments of the system according to the present invention include providing the cardholder the option of acquiring a new cardholder account is provided, which would permit the cardholder to obtain a lower convenience fee on the present or future transaction. Furthermore, this optional method step and embodiment may include the capability to issue a credit or debit card, for immediate use. Other optional method steps according to the present invention include automatically indicating alternative credit card and/or debit card options having lower interchange rates, and associated convenience fees, for the specific transaction and the capability to issue a credit or debit card, for immediate use, that was provided as an alternative credit card and/or debit card options having lower interchange rates, and associated convenience fees, for the specific transaction. The aforementioned capability provides the cardholder with the benefit of providing access to lower cost convenience fee alternatives.

Optionally, an additional step of receiving a digital or physical confirmation of the transaction may be included. Alternatively and also optionally, an additional step of receiving notice of a declined transaction is provided.

FIG. 1 displays the steps involved in a card transaction over a network-based system. In step one a cardholder presents a card to pay for goods or services. For card-not-present transactions, the cardholder provides the merchant with the account number, expiration date, and/or other transaction information through the Internet, phone or other payment channel. By way of example and not limitation, the other transaction information may include a billing address or security code. Alternatively, if the transaction is a card present transaction, the merchant or cardholder swipes the card through a magnetic-card reader, dips the card into a chip-reading device, or waives the card in front of a NCF reader.

In step 2, the merchant enters the transaction amount, and, if necessary, transmits an authorization request to the acquirer. For card not present transactions, the cardholder or service provider enters the amount, account number, and other information may be digitally or key-entered.

Steps 1 and 2 are generally known in the prior art. By contrast to the present invention, an entity of the prior art executes step 3, determination of the convenience fee, by applying a uniformly flat fee or fixed percentage or uniform combination of both based on a service provider's, merchant's or processor's underlying aggregate cost structure and/or the type of card used, the merchant, and the payment channel. Distinguishably, the present invention further considers the interchange rate for the individualized cardholder account. Furthermore, the present invention determines the convenience fee individually and does not simply calculate the convenience fee uniformly.

In step 4, the convenience fee and other transaction information is presented to the cardholder for approval. In the prior art, the convenience fee alone was presented. In the present invention, the convenience fee and optionally the fees and factors used in calculating the convenience fee, can be displayed to the cardholder for approval. Then, in step 5, if the cardholder accepts the convenience fee, the merchant or service provider transmits an authorization request to the acquirer. The acquirer sends the authorization request to an association or payment network, and, in step 6, the transaction process continues according to commercial steps, which are known and appreciated to one of ordinary skill in the art.

The present invention provides a method of completing electronic transactions from individuals' and business' cards, other electronic transaction methods, or combinations thereof, hereinafter defined and referred to as individually and collectively as electronic transactions.

Additionally, the present invention provides methods that facilitate electronic transactions to be made over the network-based system to the any transaction amount recipient, including but not limited to merchants, service providers, government agencies, creditors, banks, and online businesses. Also, the present invention includes all communications channels for making electronic transactions, including but not limited to communications via Internet-based computer, phone, smart phone, mobile device, mobile wallet, point of sale terminals, and combinations thereof.

As illustrated in FIG. 2, the system 200 comprises a server 210 with a processing unit 211. The server 210 is constructed, configured and coupled to enable communication over a network 250. The server provides for user interconnection with the server over the network using a personal computer (PC) 240 positioned remotely from the server. Furthermore, the system is operable for a multiplicity of remote personal computers or terminals 260, 270 to access the server remotely. For example, in a client/server architecture or alternatively, and preferably, a user may interconnect through the network 250 using a user device such as a mobile communication device, such as by way of example and not limitation, a mobile phone, a cell phone, smart phone, laptop computer, netbook, a terminal, personal digital assistant (PDA), or any other computing device suitable for network connection. Also, alternative architectures may be used instead of the client/server architecture. For example, a PC network, or other suitable architecture may be used. In preferred embodiments, the network 250 is the Internet, or it could be an intranet, or any other network suitable for searching, obtaining, and/or using information and/or communications, including receiving the notification and providing a response.

The system of the present invention further includes an operating system 212 installed and running on the server 210, enabling server 210 to communicate through network 250 with the remote, distributed user devices. The operating system may be any operating system known in the art that is suitable for network communication.

A memory 220 is interconnected with the server 210. Memory 220 may be integral with server 210 or may be external to the server and interconnected therewith. A program of instruction 222 is stored on memory 220. According to an exemplary embodiment, the program 222 is computer executable code for using information derived from electronic transactions made over the network, and more particularly for real-time interchange rate determination associated with received data for a credit card or debit card number provided as inputs by the cardholder user of the system. In preferred embodiments, the system is cloud computing based, with the remote client or customer computer devices merely accessing the system, inputting, sending, and receiving notification via the web, the Internet, or other network.

A remote user (cardholder) may connect to the server 210 through network 250 from a computing device 240. According to an exemplary embodiment, computing device 240 is a personal computer or smartphone device that is constructed and configured for network communication and data transfer. Computing device 240 may comprise a bus 242 interconnected to the network 250 such as through a modem, an Ethernet card, or any wired or wireless network communications components. A processing unit 244 may be interconnected with the bus 242. A memory 246 may be interconnected with the processing unit 244 through bus 242. The computing device 240 may also comprise one or more input/output devices 248, such as a mouse, a keyboard, a printer, and the like interconnected to the processing unit 244 through bus 242. A display 249, 269, 279 may be interconnected with the processing unit 244 through bus 242 for providing a graphical user interface on a display, corresponding to a website, preferably interactive GUI and website.

Computing device 240 may have a program of instruction 247, such as a driver enabling computing device 240 to interconnect with server 210 through network 250.

When the cardholder user enters inputs information into the memory 220, the server 210 creates and updates a profile database 222. The server then executes a matching program 224 against the data stored in memory 220 to match the credit card or debit card number with the corresponding interchange rate at the time of the inquiry and before the electronic online transaction is processed, which includes any data relating to the system for all time or predetermined time. The first 6-8 digits of the card number are used to automatically conduct the real-time lookup of the interchange rate for the BIN file, which includes the following factors: issuing bank, credit or debit card type, business or individual card, and combinations thereof. The program 224 detects attributes of the data, in particular interchange rates associated with the credit or debit card number received by the system, and transforms those attributes into a transparent convenience fee by combining the specific interchange rate with other fees associated with the credit or debit card. Notably, the convenience fee is not a flat fee or a flat percentage rate fee, i.e., the transparent convenience fee includes the specific interchange rate that is determined and displayed on a graphic user interface (GUI) on a display viewable by the cardholder user. Significantly, the transformation of the interchange rate specific to the card number provided, into the transparent convenience fee includes transaction level determination, i.e., only the actual fees associated with the specific card for electronic transaction are included. Preferably, messaging is automatically generated to provide the transparent convenience fee information to the cardholder user.

As illustrated in FIG. 3, a remote user (cardholder) may connect to the Electronic Payment User Interface [100] from a computing device, or directly if the Electronic Payment User Interface is on a Point-of-Sale or Virtual Terminal device at a merchant location. Via the Electronic Payment User Interface, the cardholder begins a payment transaction and enters the card data. The Payment Gateway receives the cardholder data for the associated transaction [101] and sends the data to the electronic payment Processor [102]. The Processor follows the existing payment authorization processes be transmitting the cardholder data to the Acquiring Bank [103], which uses existing Card Networks to performs the authorization of the transaction amount for the cardholder's card account [105] a the Issuing Bank. The Issuing Bank transmits the authorization response to the Acquiring Bank [107] through the Card Networks [106]. The Acquiring Bank next transmits the authorization response to the Processor [108], which then transmits the authorization response to the Payment Gateway [109]. The Payment Gateway holds the authorization response, and then transmits the transaction data to the Interchange Rate Based Convenience Fee, Service Fee, and Surcharge System [110]. The Interchange Rate Based Convenience Fee, Service Fee, and Surcharge System calculates the Interchange Fee using the authorization data and/or the BIN data from the card number, and also adds any Service Fees or Surcharges. The Interchange Rate Based Convenience Fee, Service Fee, and Surcharge System transmits these calculated data to the Payment Gateway [111], which submits the payment data to the Electronic Payment User Interface [112]. The Cardholder reads the display of the Electronic Payment User Interface which includes the payment amount and the associated Interchange Fee, Service Fee, and Surcharges (or some summation of these fees, the Convenience Fee) [113]. The cardholder can then complete the payment transaction.

As illustrated in FIG. 4, the Payment Gateway transmits card data and/or authorization data, and/or other transaction data to the Interchange Rate Based Convenience Fee, Service Fee, and Surcharge System [100]. Fee data specific to that input transaction is output to the Payment Gateway once the specific fees have been calculated by the Interchange Rate Based Convenience Fee, Service Fee, and Surcharge System [102]. The Interchange Rate Based Convenience Fee, Service Fee, and Surcharge System reads the form the Payment Gateway data and calculates a specific Interchange Fee based on the data from the Payment Gateway and the stored data in the Interchange Fee Table [201]. Calculations for any Service Fee [202], Surcharge [203], or Other fees [204] that apply to that transaction are made by the Interchange Rate Based Convenience Fee, Service Fee, and Surcharge System. External to the Interchange Rate Based Convenience Fee, Service Fee, and Surcharge System are the Fee Creation Entities, including the Acquiring Bank, the Payment Processor, the Card Associations, and any other entities that create fees for electronic payment transactions. These Entities publish their fees in tables (machine or human-readable) or through agreements with Merchants or Payment Gateways. The Interchange Rate Based Convenience Fee, Service Fee, and Surcharge System receives the fee amount from the Fee Creation Entities through a machine-based transmittal or manual human input [302] [303] [304]. The Interchange Rate Based Convenience Fee, Service Fee, and Surcharge System maintains databases, tables, or other computer-based storage schemes to store the fee data. The Interchange Rate Based Convenience Fee, Service Fee, and Surcharge System can add, modify, and delete the fee tables whenever new fee data is input from the Fee Creation Entities.

In one embodiment of the present invention, the message automatically generated to the cardholder user is transmitted by the system over the network and viewable as a graphic display of the information. Also, preferably, a table is provided indicating the itemized components of the convenience fee. Alternative card types may be suggested where a lower fee is possible for the cardholder if a different card is used, i.e., a second card number is provided as an alternative to the first card number.

The present invention and preferred embodiments supporting best mode of application thereof as set forth in the foregoing, are supplied as examples and not intended to limit the scope of the invention thereto.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention as set forth in the claims.

1. A method for processing transactions electronically over a network-based system comprising the steps of:
providing a system and a communications network that cooperate for managing electronic transactions online;
initiating a transaction on behalf of a cardholder;
receiving electronic transaction information corresponding to a cardholder account and whether a card is present for the transaction;
automatically making a real-time bank identification number (BIN) lookup for determining a real-time interchange rate associated with the cardholder account;
automatically transforming the real-time interchange rate, along with other factors and fees, into a convenience fee that is dynamically determined at a point-of-sale terminal, a computing device or a virtual terminal for the cardholder; and
presenting the convenience fee to the cardholder for approval.

2. The method of claim 1, wherein the step of receiving electronic transaction information includes credit card or debit card information.

3. The method of claim 1, wherein the steps are repeated until a step of receiving an approval input from the cardholder to process the transaction.

4. The method of claim 3, further including the step of transmitting the electronic transaction information to a processor for processing.

5. The method of claim 1, further including the step of providing a visual representation of the real-time interchange rate and the other factors and fees compared with alternative credit card or debit card types.

6. The method of claim 5, further including step of issuing a credit or debit card of the alternative credit or debit card type.

7. The method of claim 1, wherein the step of presenting the convenience fee to the cardholder for approval further includes a tabular listing of at least one other factor and fees.

8. The method of claim 1, further including the step of providing alternative credit card or debit card types that have a corresponding lower total fee.

9. A method for processing payments electronically over a network-based system comprising the steps of:
providing a system and a communications network that cooperate for managing electronic payments online;
initiating a transaction for making a payment on behalf of a cardholder;
receiving electronic payment information or data corresponding to a cardholder account and whether a card is present for the transaction;
automatically determining a real-time interchange rate associated with the cardholder account;
automatically transforming the real-time interchange rate and at least one factor or fee into a convenience fee;
presenting the convenience fee to the cardholder for approval; and
presenting the at least one itemized factor or fee to the cardholder.

10. The method of claim 9, further including the step of transmitting the electronic transaction information to a processor for processing.

11. The method of claim 9, further including the step of providing a visual representation of the real-time interchange rate and the other factors and fees compared with alternative credit card or debit card types.

12. The method of claim 11, further including step of issuing a credit or debit card of the alternative credit or debit card type.

13. The method of claim 9, wherein the step of presenting the convenience fee to the cardholder for approval further includes a tabular listing of at least one other factor and fees.

14. The method of claim 9, further including the step of providing alternative credit card or debit card types that have a corresponding lower total fee.

15. A method for processing payments electronically over a network-based system comprising the steps of:
providing a system and a communications network that cooperate for managing electronic payments online;
initiating a transaction for making a payment on behalf of a cardholder;
receiving electronic payment information or data corresponding to multiple cardholder accounts;
automatically making a real-time bank identification number (BIN) lookup for determining a real-time interchange rate associated with each of the multiple cardholder accounts;
automatically transforming each of the real-time interchange rates and at least one factor or fee into convenience fees;
presenting each of the convenience fees to the cardholder for approval.

16. The method of claim 15, further including the step of transmitting the electronic transaction information to a processor for processing.

17. The method of claim 15, further including the step of providing a visual representation of the real-time interchange rate and the other factors and fees compared with alternative credit card or debit card types.

18. The method of claim 17, further including step of issuing a credit or debit card of the alternative credit or debit card type.

19. The method of claim 15, wherein the step of presenting the convenience fee to the cardholder for approval further includes a tabular listing of at least one other factor and fees.

20. The method of claim 15, further including the step of providing alternative credit card or debit card types that have a corresponding lower total fee.
